(19) United States
(12) Patent Application Publication
(10) Pub. No.: US 2009/0328185 A1
(43) Pub. Date: Dec. 31, 2009

(54) Detecting exploit code in network flows

(76) Inventors: Eric Van den Berg, Hoboken, NJ (US); Ramkumar Chinchani, Santa Clara, CA (US)

Correspondence Address: FITCH EVEN TABIN & FLANNERY, 120 SOUTH LASALLE STREET, SUITE 1600, CHICAGO, IL, 60603-3406, US

(21) Appl. No.: 11/260,914

(22) Filed: Oct. 28, 2005

Related U.S. Application Data
(60) Provisional application No. 60/624,996, filed on Nov. 4, 2004.

(51) Int. Cl. G06F 11/30; G06F 17/00; G06F 15/173

(52) U.S. Cl. 726/13; 709/224; 726/23

(57) ABSTRACT

Disclosed is a method and apparatus for detecting exploit code in network flows. Network data packets are intercepted by a flow monitor which generates data flows from the intercepted data packets. A content filter filters out legitimate programs from the data flows, and the unfiltered portions are provided to a code recognizer which detects executable code. Any embedded executable code in the unfiltered data flow portions is identified as a suspected exploit in the network flow. The executable code recognizer recognizes executable code by performing convergent binary disassembly on the unfiltered portions of the data flows. The executable code recognizer then constructs a control flow graph and performs control flow analysis, data flow analysis, and constraint enforcement in order to detect executable code. In addition to identifying detected executable code as a potential exploit, the detected executable code may then be used in order to generate a signature of the potential exploit, for use by other systems in detecting the exploit.

### RELATED APPLICATION

This application claims the benefit of U.S. Provisional Application No. 60/624,996 filed Nov. 4, 2004, which is incorporated herein by reference.

### GOVERNMENT LICENSE RIGHTS

This invention was made with Government support under FA8750-04-C-0249 awarded by the Air Force Research Laboratory. The Government has certain rights in this invention.

### BACKGROUND OF THE INVENTION

The present invention relates generally to detecting computer system exploits, and more particularly to detecting exploit code in network flows.

A significant problem with networked computers and computer systems is their susceptibility to external attacks. One type of attack is the exploitation of vulnerabilities in network services running on networked computers. A network service running on a computer is associated with a network port, and the port may remain open for connection with other networked computers. One type of exploit which takes advantage of open network ports is referred to as a worm. A worm is self propagating exploit code which, once established on a particular host computer, may use the host computer in order to infect another computer. These worms present a significant problem to networked computers.

The origins of computer vulnerabilities may be traced back to software bugs which leave the computer open to attacks. Due to the complexity of software, not all bugs can be detected and removed prior to release of the software, thus leaving the computers vulnerable to attacks.

There are several known techniques for combating computer attacks. One approach is to detect the execution of a worm or other exploit code on a computer when the exploit code begins to execute. This approach typically requires that some type of software monitor be executing on the host computer at all times, such that when a piece of exploit code attempts to execute, the monitor will detect the exploit code and prevent any harmful code from executing. Another approach is intrusion detection, which also requires some type of monitoring software on the host system whereby the monitoring software detects unwanted intrusion into network ports. A common problem with both of these techniques is the undesirable use of valuable processing and other computer resources, which imposes undesirable overhead on the host computer system.

Another approach to combating computer attacks involves detecting malicious exploit code inside network flows. In accordance with this technique, data traffic is analyzed within the network itself in order to detect malicious exploit code. An advantage of this approach is that it is proactive and countermeasures can be taken before the exploit code reaches a host computer.

One type of network flow analysis involves pattern matching, in which a system attempts to detect a known pattern, called a signature, within network data packets. While signature based detection systems are relatively easy to implement and perform well, their security guarantees are only as strong as the signature repository. Evasion of such a system requires only that the exploit avoid any pattern within the signature repository. This avoidance may be achieved by altering the exploit code or code sequence (called metamorphism), by encrypting the exploit code (called polymorphism) or by discovering a new, yet unknown, vulnerability and generating the exploit code necessary to exploit the newly discovered vulnerability (called a zero-day exploit). As a general rule, signatures must be long so that they are specific enough to reduce false positives which may occur when normal data coincidentally matches exploit code signatures. Also, the number of signatures must be kept small in order to achieve scalability, since the signature matching process can become computationally and storage intensive. These two goals are seriously hindered by polymorphism and metamorphism, and pose significant challenges to signature-based detection systems.

Other network flow analysis techniques, in addition to signature based techniques, are also available. Many of these techniques are based on the fact that typical exploit code generally consists of three distinct components: 1) a return address block, 2) a NOOP sled, and 3) a payload. Exploit code having this structure generally utilizes a class of exploits which take advantage of a buffer overflow vulnerability in a host computer. Generally, and as is well known in the art, by causing a buffer overflow condition, an attacker is often able to force a computer to begin code execution at the specified return address block. A series of NOOP (no operation) instructions (the NOOP sled) eventually leads to execution of exploit code in the payload, which results in infection of the host computer. Several flow analysis techniques take advantage of this known structure, by analyzing network flows and detecting various of these components. For example, several prior techniques focus on the NOOP sled and attempt to detect NOOP sleds in the network flows. For example, T. Toth and C. Krugel, “Accurate Buffer Overflow Detection Via Abstract Payload Execution”, Proceedings of 5^{th} International Symposium on Recent Advances in Intrusion Detection (RAID), Zurich, Switzerland, Oct. 16-18, 2003, pages 274-291, describes a technique that disassembles the network data to detect sequences of executable instructions bounded by branch or invalid instructions, where longer such sequences are greater evidence of a NOOP sled. However, one problem with this detection technique is that it can be defeated by interspersing branch instructions among normal code, thereby resulting in short sequences.

Another technique based upon the typical exploit code structure is described in A. Pasupulati, J. Coit, K. Levitt, S. Wu, S. Li, R. Kuo, and K. Fan, “Buttercup: On Network-Based Detection of Polymorphic Buffer Overflow Vulnerabilities, in 9^{th} IEEE/IFIP Network Operation and Management Symposium (NOMS 2004), Seoul, Korea, May 2004. That paper describes a technique to detect the return address component by matching it against candidate buffer addresses. One problem with this technique is that the return address component may be very small, so that when used as a signature, it may not be specific enough, therefore resulting in too many false positives. In addition, even small changes in software are likely to alter buffer addresses in memory, thereby requiring frequent updates to the signature list and high administrative overhead.

Yet another technique based upon the typical exploit code structure is described in K. Wang and S. J. Stolfo, Anomalous Payload-Based Network Intrusion Detection, Proceedings of 7^{th} International Symposium on Recent Advances in Intrusion Detection (RAID), France, Sep. 15-17, 2004, pages 203-222, which proposes a payload based anomaly detection system which works by first training with normal network flow traffic and subsequently using several byte-level statistical measures to detect exploit code. One problem with this approach is that it is possible to evade detection by implementing the exploit code in such a way that it statistically mimics normal traffic.

### BRIEF SUMMARY OF THE INVENTION

The present invention provides a method and apparatus for detecting exploit code in network flows.

In one embodiment, network data packets are intercepted by a flow monitor which generates data flows from the intercepted data packets. A content filter filters out at least portions of the data flows, and the unfiltered portions are provided to a code recognizer which detects executable code in the unfiltered portions of the data flows. The content filter filters out legitimate programs in the data flows, such that the unfiltered portions that are provided to the code recognizer are expected not to have embedded executable code. Any embedded executable code in the unfiltered data flow portions is a suspected exploit in the network flow. Thus, by recognizing executable code in the unfiltered portions of the data flows, an exploit detector in accordance with the present invention can identify potential exploit code within the network flows.

In one embodiment, the executable code recognizer recognizes executable code by performing convergent binary disassembly on the unfiltered portions of the data flows. The executable code recognizer then constructs a control flow graph and performs control flow analysis, data flow analysis, and constraint enforcement in order to detect executable code. In addition to identifying detected executable code as a potential exploit, the detected executable code may then be used in order to generate a signature of the potential exploit, for use by other systems in detecting the exploit.

These and other advantages of the invention will be apparent to those of ordinary skill in the art by reference to the following detailed description and the accompanying drawings.

### BRIEF DESCRIPTION OF THE DRAWINGS

FIG. 1 shows a system in accordance with an embodiment of the present invention for detecting exploit code in network flows;

FIG. 2 shows a high level block diagram of a computer which may be programmed to perform functions in accordance with the present invention;

FIG. 3 illustrates the filtering function of the content filter;

FIG. 4A shows an exemplary byte stream;

FIGS. 4B-4D illustrate the disassembly of the byte stream of FIG. 4A starting at various offsets;

FIG. 5 shows an overview of the general instruction format for the IA-32 architecture;

FIG. 6 shows a partial view of a control flow graph instance;

FIG. 7 is a graph that plots the probability that synchronization occurs beyond n bytes after start of disassembly; and

FIG. 8 shows a high level flowchart of the steps performed by the code recognizer.

### DETAILED DESCRIPTION

FIG. 1 shows a system in accordance with an embodiment of the present invention for detecting exploit code in network flows. FIG. 1 shows an exploit detector 102 comprising a flow monitor 104, a content filter 106, a code recognizer 108 and a malicious program analyzer 110. FIG. 1 also shows three network flows 118, 120, 122 associated with three host computers 112, 114, 116 respectively. Flow 122 is shown containing worm code 124, to illustrate how exploit code may be embedded in a network flow. While FIG. 1 shows the three network flows as incoming flows to the hosts, one skilled in the art will readily recognize that the present invention may be used to analyze outgoing flows as well as incoming flows. Only incoming flows are shown for clarity.

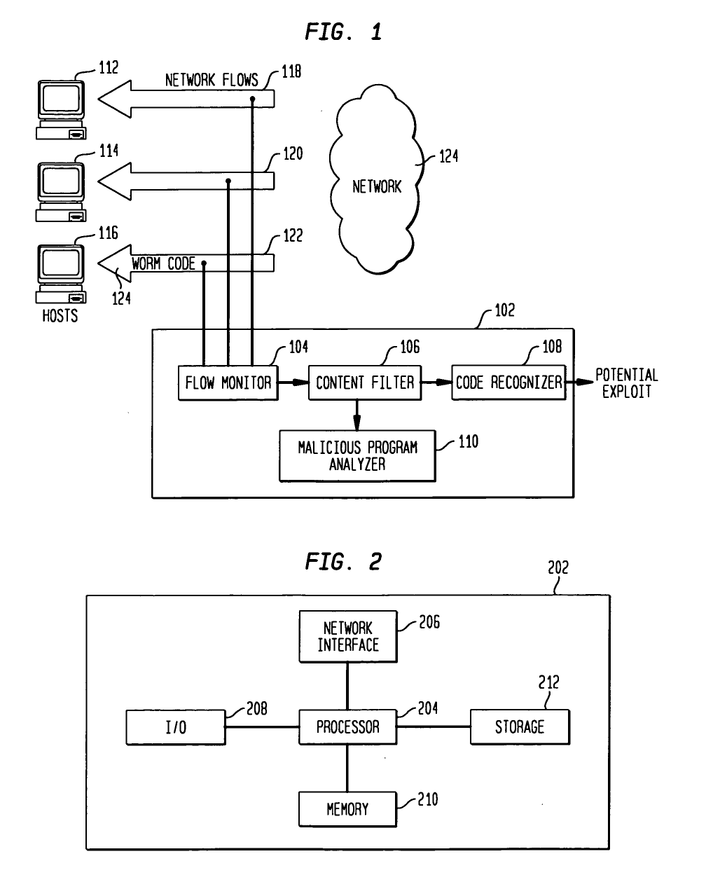

It is noted that FIG. 1 shows a high level functional block diagram of an exploit detector 102 in accordance with an embodiment of the invention. The components of exploit detector 102 are shown as functional blocks, each of which performs a portion of the processing. The exploit detector 102 may be implemented using an appropriately programmed computer. Such computers are well known in the art, and may be implemented, for example, using well known computer processors, memory units, storage devices, computer software, and other components. A high level block diagram of such a computer is shown in FIG. 2. Computer 202 contains a processor 204 which controls the overall operation of computer 202 by executing computer program instructions which define such operation. The computer program instructions may be stored in a storage device 212 (e.g., magnetic disk) and loaded into memory 210 when execution of the computer program instructions is desired. Thus, the steps performed by the computer 202 will be defined by computer program instructions stored in memory 210 and/or storage 212 and executed by processor 204. Computer 202 also includes one or more network interfaces 206 for communicating with other devices via a network. Computer 202 also includes input/output 208 which represents devices which allow for user interaction with the computer 202 (e.g., display, keyboard, mouse, speakers, buttons, etc.). One skilled in the art will recognize that an implementation of an actual computer will contain other components as well, and that FIG. 2 is a high level representation of some of the components of such a computer for illustrative purposes. With reference to FIG. 1, each of the functional blocks may be implemented, for example, by different software modules executed by processor 204 as appropriate. In various embodiments, the various functions of exploit detector 102 may be performed by hardware, software, and various combinations of hardware and software.

Returning now to FIG. 1, the flow monitor 104 intercepts data packets from the network flows 112, 114, 116 and reconstructs the various data flows that are within the network flows. As used herein, the term network flow corresponds to all the network traffic flowing between various network devices, without reference to a particular type of data or particular connection between endpoints. The term data flow corresponds to the data packets associated with a particular connection between two endpoints. Network flows can be unidirectional or bidirectional, and both directions can contain executable malicious (e.g., worm) code. In one embodiment, the flow monitor 104 may be implemented using tcpflow which is a known software utility that captures network flows and reassembles the network packets to correspond to the actual data flows. Transmission Control Protocol (TCP) data flows are fairly straightforward to reconstruct, because the TCP protocol guarantees data delivery and also guarantees that packets will be delivered in the same order in which they were sent. User Datagram Protocol (UDP) data flows are not as straightforward to reconstruct, because UDP is a connectionless protocol and does not guarantee reliable communication. If UDP packets arrive out of order, then the analysis of the data flow (as described below) may not identify any embedded malicious exploit code. However, this is not a serious issue because if the UDP packets arrive in an order different than what the exploit code author intended, then it is unlikely that infection of the host computer will be successful. The data flows reconstructed by the flow monitor 104 are passed to the content filter 106 for further processing.

As described in further detail below, the code recognizer 108 identifies potential exploit code by recognizing executable code in network flows. Some network flows, however, may contain legitimate programs that can pass the tests of the code recognizer 108 (as described below) therefore leading to false positive identification of potential exploit code. It is therefore necessary to make an additional distinction between program-like code and legitimate programs. The content filter 106 filters content before it reaches the code recognizer 108. In one embodiment, the content filter 106 filters out program code that can be identified as being a legitimate program. It is therefore necessary to specify which services and associated data flows may or may not contain executable code. This information is represented as a 3-tuple (p, r, v), where p is the standard port number of a service, r is the type of the network flow content which can be data-only (denoted by d) or data-and-executable (denoted by dx), and v is the direction of the flow, which is either incoming (denoted by i) or outgoing (denoted by o). For example, (ftp, d, i) indicates an incoming flow over the ftp port has data-only content type. Further fine-grained rules could be specified on a per-host basis. However, for a large organization that contains several hundred hosts, the number of such tuples can be very large. This makes fine-grained specification undesirable because it puts a large burden on the system administrator. If a rule is not specified, then data-only network flow content is assumed by default for the sake of convenience since most network flows carry data only.

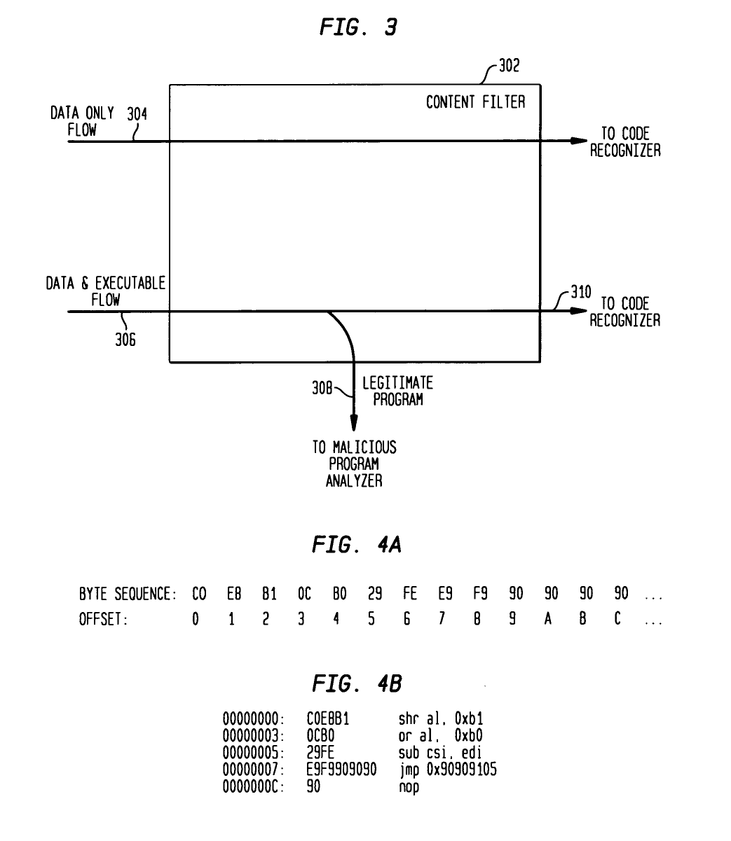

The filtering function of the content filter is illustrated in FIG. 3. FIG. 3 shows a content filter 302 receiving two types of data flows. Data only flows 304 and data plus executable flows 306. If the 3-tuple rule specifies a data flow which is a data plus executable flow, such as flow 306, then the content filter 302 must make a determination as to whether the flow contains a legitimate program. If the flow contains a legitimate program, then the legitimate program content 308 is filtered out and provided to the malicious program analyzer (as discussed further below). If the content is not a legitimate program, the content 310 is passed to the code recognizer for further analysis. If the 3-tuple rule specifies a flow which is data only, such as flow 304, then the flow is passed to the code recognizer for further analysis because it is assumed not to contain a legitimate program.

With respect to the legitimate program content 308, in one embodiment the content filter 106 is configured to identify Linux and Microsoft Windows executable programs as legitimate program content. Typically, the occurrence of programs inside flows is uncommon and can generally be attributed to downloads of third-party software from the Internet (although the occurrence of programs could be much higher in peer-to-peer file sharing networks). Programs for Linux and Windows platforms generally follow standard executable formats. Linux programs generally follow the well known Executable and Linking Format (ELF), which is described in, Tool Interface Standard (TIS), Executable and Linking Format (ELF) Specification, Version 1.2, 1995. Windows programs generally follow the well known Portable Executable (PE) format, which is described in Microsoft Portable Executable and Common Object File Format Specification, Revision 6.0, 1999.

The process for detecting a Linux ELF executable will be described herein below. The process for detecting a Windows PE executable is similar, and could be readily implemented by one skilled in the art given the description herein. The content filter 106 scans the network flow received from the flow monitor 104 for the characters ‘ELF’ or equivalently, the consecutive bytes 454C46 (in hexadecimal). This byte sequence typically marks the start of a valid ELF executable. Next, the content filter 106 looks for the following indications of legitimate programs.

One legitimate program indicator is an ELF Header. An ELF header contains information which describes the layout of the entire program, but for purposes of the content filter 106, only certain fields are required. In one embodiment, the following fields are checked: 1) the e_ident field must contain legitimate machine independent information, 2) the e_machine field must contain EM_{—}386, and 3) the e_version field must contain a legitimate version. We note that with respect to headers, the format of a Windows PE header closely resembles an ELF header and similar checks may be performed on a Windows header. A Windows PE executable file starts with a legacy DOS header, which contains two fields of interest e_magic, which must be the characters ‘MZ’ or equivalently the bytes 5A4D (in hexadecimal), and e_Ifanew, which is the offset of the PE header. While analysis of the ELF header is generally adequate to identify a legitimate program, further confirmation may be obtained by performing the following checks.

Another legitimate program indicator is the dynamic segment. Using the ELF header, the offset of the program header and the offset of the dynamic segment are determined. If the dynamic segment exists, then the executable uses dynamic linkage and the segment must contain the names of legitimate external shared libraries such as libc.so.6. The name of a legitimate external shared library in the dynamic segment field is a further indicia of a legitimate program.

Other legitimate program indicators are symbol and string tables. Again, using the ELF header the offset of symbol and string tables are determined. In a legitimate program, the string tables will contain only printable characters. Also, the symbol table entries in a legitimate program will point to valid offsets into the string table.

It is highly unlikely that normal network data will contain all of the above described indicia of a legitimate program. Thus, if all of the indicators are satisfied, then it is reasonable to determine that a legitimate executable program has been found. Of course, various combinations of the above described indicia, as well as other indicia, may be used depending upon the particular embodiment. With reference again to FIG. 3, if legitimate program content is found by the content filter 302, then it is passed to the malicious program analyzer 110. We have described herein particular analysis of data flows to identify legitimate Linux and Windows programs. It should be recognized that one skilled in the art could implement various other tests for identifying legitimate programs in a data flow.

The malicious program analyzer 110 may be provided to analyze programs to determine whether, even though they are legitimate Windows or Linux programs, are nonetheless malicious. For example, the malicious program analyzer 110 may be anti-virus software which is well known in the art. The use of a malicious program analyzer 110 is optional, and the details of such a malicious program analyzer 110 will not be provided herein, as various types of such programs are well known in the art and may be used in conjunction with the exploit detector 102.

As shown in FIG. 3, content that is contained within a data plus executable flow 306, and which is not filtered out as a legitimate program 308, is passed to the code recognizer as content 310. Content that is contained within a data only flow 304 is also passed to the code recognizer. At this point, any content being passed to the code recognizer which contains executable code may be potential exploit code and should be identified as such. Thus, the content is passed to code recognizer 108, which analyzes the received content to determine if it contains an executable code segment as follows.

Static analysis of binary programs typically begins with disassembly followed by data and control flow analysis. In general, the effectiveness of static analysis greatly depends on how accurately the execution stream is reconstructed (i.e., disassembled). However, disassembly turns out to be a significant challenge as the code recognizer 108 does not know if a network flow contains executable code fragments, and if it does, it does not know where these code fragments are located within the data stream. We will now describe an advantageous disassembly technique called convergent binary disassembly, which is useful for fast static analysis.

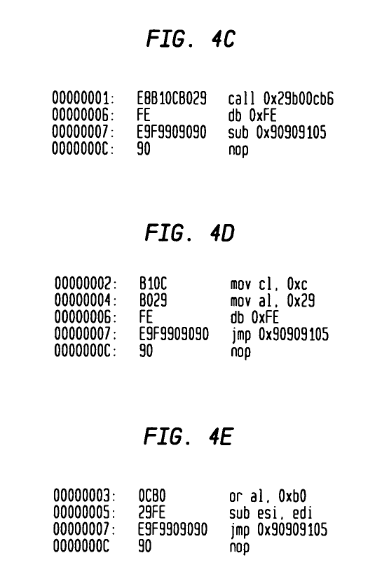

A property of binary disassembly of code based on Intel processors is that it tends to converge to the same instruction stream with the loss of only a few instructions. This is interesting because this appears to occur in spite of the byte stream being primarily data and also when disassembly is performed beginning at different offsets. Consider the byte stream shown in FIG. 4A, which consists of a random preamble followed by a NOOP sled of NOP (0x90) instructions. The byte stream is disassembled starting at offsets 0, 1, 2 and 3, and the outputs of such disassembly are shown in FIGS. 4B, 4C, 4D and 4E respectively. These figures illustrate three aspects of interpreting a data stream as Intel binary code. First, almost every data byte disassembles into a legal Intel instruction. Second, all disassembly streams rapidly converge to the NOOP sled regardless of the offset and the preceding garbage data. Third, a few instructions from the NOOP sled are lost, but in spite of this, convergence occurs.

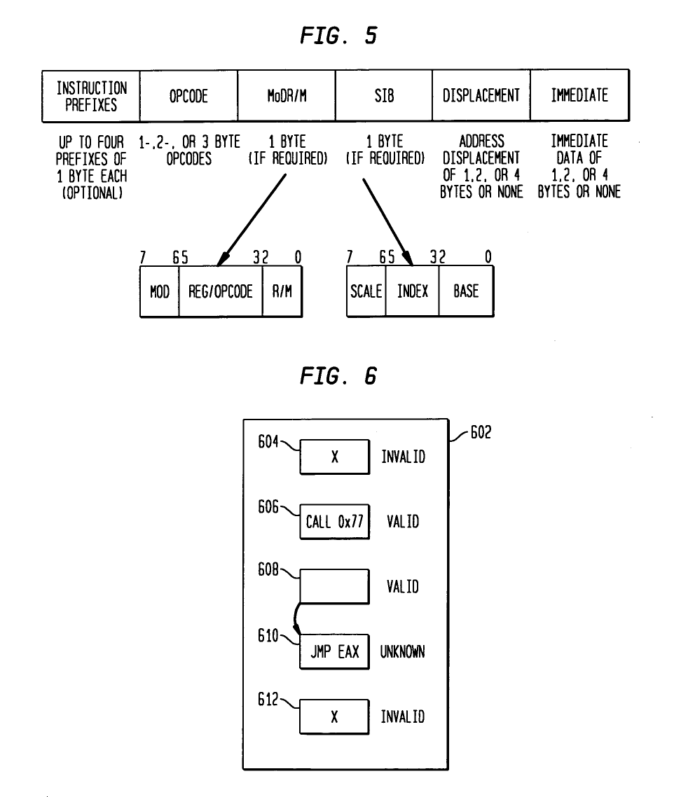

The phenomenon of convergence can be explained by the nature of the Intel instruction set. Since Intel uses a complex instruction set computer architecture, the instruction set is very dense. Out of the 256 possible values for a given start byte to disassemble from, only one (0xF1) is illegal. Another related aspect for rapid convergence is that Intel uses a variable-length instruction set. FIG. 5 gives an overview of the general instruction format for the IA-32 architecture. The length of the actual decoded instruction depends not only on the opcode, which may be 1-3 bytes long, but also on the directives provided by the prefix, ModR/M and SIB bytes wherever applicable. Also note that not all start bytes will lead to a successful disassembly and in such an event, they are decoded as a data byte as shown in FIGS. 4C and 4D at offset 0x00000006.

A more formal mathematical analysis of the convergence phenomenon is given as follows. Given a byte stream, assume that the actual exploit code is embedded at some offset x=0, 1, 2, . . . . Ideally, binary disassembly to recover the instruction stream should begin or at least coincide at x. However, since we do not know x, we start from the first byte in the byte stream. We are interested in knowing how soon after x does disassembly synchronize with the actual instruction stream of the exploit code.

To answer this question, we model the process of disassembly as a random walk over the byte stream where each byte corresponds to a state in the state space. Disassembly is a strictly forward-moving random walk and the size of each step is given by the length of the instruction decoded at a given byte. There are two random walks, one corresponding to our disassembly and the other corresponding to the actual instruction stream. Note that both random walks do not have to move simultaneously nor do they take the same number of steps to reach the point where they coincide.

Translating to mathematical terms, let L={1, . . . , N} be the set of possible step sizes or instruction lengths, occurring with probabilities {p₁ . . . , p_{N}}. For the first walk, let the step sizes be {X₁ . . . , |XᵢεL}, and define

$${Z}_{k} = {\sum }_{j = 1}^{k} {x}_{j} .$$

Similarly, for the second walk, let step sizes be {\tilde{X}₁ . . . , |\tilde{X}ᵢεL} and

$${\tilde{Z}}_{k} = {\sum }_{j = 1}^{k} {\tilde{x}}_{j} .$$

We are interested in finding the probability that the random walks {Zₖ} and {\tilde{Z}ₖ} intersect, and if so, at which byte position.

One way to do this, is by studying the ‘gaps’, defined as follows: let G₀=0, G₁=|\tilde{Z}₁−Z₁|. G₁=0 if \tilde{Z}₁=Z₁, in which case the walks intersect after 1 step. In case G₁>0, suppose without loss of generality that \tilde{Z}₁>Z₁. In terms of our application: {Zₖ} is the walk corresponding to our disassembly, and {\tilde{Z}ₖ} is the actual instruction stream. Define k₂=inf{k:Zₖ≧\tilde{Z}₁} and G₂=Zₖ₂−\tilde{Z}₁. In general Z and \tilde{Z} change roles of ‘leader’ and ‘laggard’ in the definition of each ‘gap’ variable Gₙ. The {Gₙ} form a Markov chain. If the Markov chain is irreducible, the random walks will intersect with positive probability, in fact at the first time the gap size is 0. Let

T=inf{n>0:Gₙ=0}

be the first time the walks intersect. The byte position in the program block where this intersection occurs is given by

$${Z}_{T} = {Z}_{1} + {\sum }_{i = 1}^{T} {G}_{i} .$$

In general, we do not know Z₁, our initial position in the program block, because we do not know the program entry point. Therefore, we are most interested in the quantity

$${\sum }_{i = 1}^{T} {G}_{i}$$

representing the number of byte positions after the disassembly starting point that synchronization occurs. Using partitions and multinomial distributions, we can compute the matrix of transition probabilities

pₙ(i,j)=P(Gₙ₊₁=j|Gₙ=i)

for each i,jε{0, 1, . . . N−1}. In fact pₙ(i,j)=p(i,j) does not depend on n, i.e. the Markov chain is homogeneous. The matrix allows us, for example, to compute the probability that the two random walks will intersect n positions after disassembly starts.

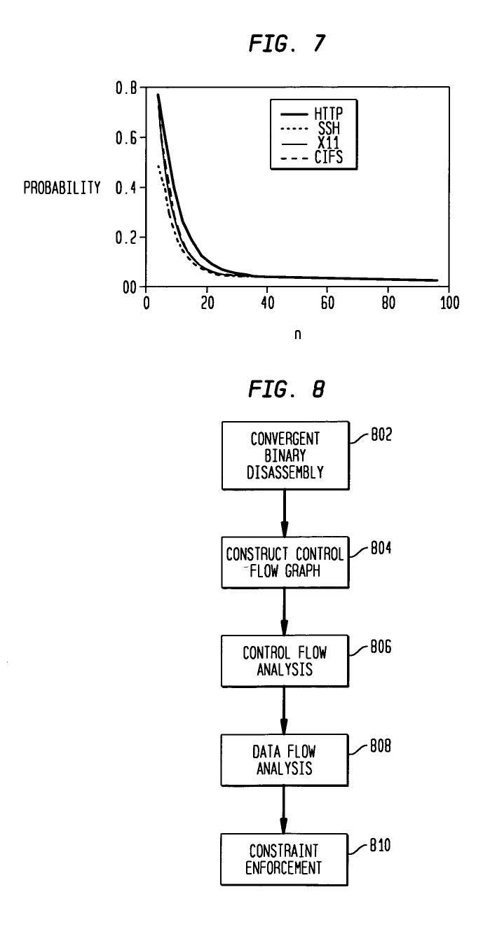

The instruction length probabilities {p₁, . . . , p_{N}} required for the above computations are dependent on the byte content of network flows. The instruction length probabilities were obtained by disassembly and statistical computations over the same network flows chosen during empirical analysis (HTTP, SSH, XII, CIFS). In FIG. 7 we have plotted the probability

$$P ( {\sum }_{i = 1}^{T} {G}_{i} > n ) ,$$

that intersection (synchronization) occurs beyond n bytes after start of disassembly, for n=0, . . . 99.

It is clear that this probability drops fast, in fact with probability 0.95 the disassembly “walk” and the “program walk” will have intersected on or before the 21^{st} (HTTP), 16^{th} (SSH), 15^{th} (XII) and 16^{th} (CIFS) byte respectively, after the disassembly started. On average, the walks will intersect after just 6.3 (HTTP), 4.5 (SSH), 3.2 (XII) and 4.3 (CIFS) bytes respectively.

From a security standpoint, static analysis is often used to find vulnerabilities and related software bugs in program code. It is also used to determine if a given program contains malicious code or not. However, due to code obfuscation techniques and undecidability of aliasing, accurate static analysis within reasonable time bounds is a very hard problem. On one hand, superficial static analysis is efficient but may lead to poor coverage, while on the other hand, high accuracy typically entails a prohibitively large processing time. In general terms, our approach uses static analysis over network flows, and in order to realize an online network-based implementation, efficiency is an important design goal. Normally, this could translate to poor accuracy, but our approach uses static analysis only to devise a process of elimination, which is based on the premise that an exploit code is subject to several constraints in terms of the exploit code size and control flow. These constraints are then used to help determine if a byte stream is data or program-like code.

There are two general categories of exploit code from a static analysis viewpoint depending on the amount of information that can be recovered. The first category includes those types of exploit code which are transmitted in plain view such as known exploits, zero-day exploits and metamorphic exploits. The second category contains exploit code which is minimally exposed but still contains some hint of control flow. Polymorphic code belongs to this category. Due to this fundamental difference, we approach the process of elimination for polymorphic exploit slightly differently although the basic methodology is still on static analysis. Note that if both polymorphism and metamorphism are used, then the former is the dominant obfuscation. We now turn to the details of our approach starting with binary disassembly

The details of the functioning of the code recognizer 106 will now be described in conjunction with FIG. 8 which shows a high level flowchart of the steps performed by the code recognizer 108. The first step 802 is convergent binary disassembly of the data flow content, as described above. However, there are caveats to relying entirely on convergence. First, the technique is lossy. While loss of instructions on the NOOP sled is not serious, loss of instructions inside the exploit code can be serious. It is desirable to recover as many branch instructions as possible from the code, but this comes at the price of a large processing overhead. Therefore, depending on whether the emphasis is on efficiency or accuracy, two disassembly strategies may be used. The first strategy is efficient, and the approach is to perform binary disassembly starting from the first byte without any additional processing. The convergence property described above will ensure that at least a majority of instructions, including branch instructions, have been recovered. However, this approach is not resilient to data injection, which is a technique used to evade correct instruction disassembly by deliberately inserting random data between valid instructions. The second strategy emphasizes accuracy. Using this approach, the network flow is scanned for opcodes corresponding to branch instructions and these instructions are recovered first. Full disassembly is then performed over the resulting smaller blocks. As a result, no branch instructions are lost. This approach is slower not only because of an additional pass over the network flow but also because of the number of potential basic blocks that may be identified. The resulting overhead could be significant depending on the network flow content. For example, large overheads can be expected for network flows carrying ASCII text such as HTTP traffic because several conditional branch instructions are also printable characters, such as the ‘t’ and ‘u’, which binary disassembly will interpret as jump on equal (je) and jump on not equal (jne) respectively. The choice of disassembly technique will depend on the particular implementation.

After binary disassembly, the code recognizer 108 performs control and data flow analysis. First, in step 804, the code recognizer 108 constructs a control flow graph (CFG). Basic blocks are identified via block leaders, whereby the first instruction is a block leader, the target of a branch instruction is a block leader, and the instruction following a branch instruction is also a block leader. A basic block is essentially a sequence of instructions in which flow of control enters at the first instruction and leaves via the last. For each block leader, its basic block consists of the leader and all statements up to, but not including, the next block leader. Each basic block is associated with one of three states. A basic block is associated with a valid state if the branch instruction at the end of the block has a valid branch target. A basic block is associated with an invalid state if the branch target at the end of the block has an invalid branch target. A basic block is associated with an unknown state if the branch target at the end of the block is unknown. This information helps in pruning the CFG. Each node in the CFG is a basic block, and each directed edge indicates a potential control flow. Control predicate information (i.e., true or false on outgoing edges of a conditional branch) are ignored. However, for each basic block tagged as invalid, all incoming and outgoing edges are removed, because that block cannot appear in any execution path. Also, for any block, if there is only one outgoing edge and that edge is incident on an invalid block, then that block is also deemed invalid. Once all blocks have been processed, the required CFG is known.

A partial view of a typical CFG instance is shown in FIG. 6 as 602. In a typical CFG, invalid blocks form a large majority of the blocks and they are excluded from any further analysis. After construction of the control flow graph in step 804, the code recognizer 108 performs control flow analysis in step 806 in order to reduce the problem size for static analysis. The remaining blocks in a CFG may form one or more disjoint chains (or subgraphs), each in turn consisting of one or more blocks. In the CFG 602 of FIG. 6, blocks 604 and 612 are invalid, block 606 is valid and ends in a valid library call, and blocks 608 and 610 form a chain, but the branch instruction target in block 610 is unknown. Note that the CFG 602 does not have a unique entry and exit node, and each chain is analyzed separately.

Data flow analysis based on program slicing is used to continue the process of elimination in step 808. Program slicing is a decomposition technique which extracts only parts of a program relevant to a specific computation. We use the backward static slicing technique approach described in Mark Weiser, Program Slicing, Proceedings of the 5th International Conference on Software Engineering, San Diego, Calif., United States, Pages: 439-449, 1981, which is incorporated herein by reference. This approach uses the control flow graph as an intermediate representation for the slicing algorithm. This algorithm has a running time complexity of O(v xn xe), where v, n, e are the numbers of variables, vertices and edges in the CFG, respectively. Given that there are only a fixed number of registers on the Intel platform, and that the number of vertices and edges in a typical CFG is almost the same, the running time is O(n²). Other approaches exist which use different representations such as program dependence graphs (PDG) and system dependence graphs (SDG), and perform graph reachability based analysis. However, these algorithms incur additional representation overheads and are more relevant when accuracy is paramount.

In general, a few properties are true of any chain in the reduced CFG. Every block which is not the last block in the chain has a branch target which is an offset into the network flow and points to its successor block. For the last block in a chain, the following cases devise a process of elimination which differentiates between a flow containing data only and a flow containing potential executable exploit code.

The first case is the case of an obvious library call. If the last instruction in a chain ends in a branch instruction, specifically call/jmp, but with an obvious target (immediate/absolute addressing), then that target must be a library call address. Any other valid branch instruction with an immediate branch target would appear earlier in the chain and point to the next valid block. The corresponding chain can be executed only if the stack is in a consistent state before the library call, hence, we expect push instructions before the last branch instruction. The code recognizer computes a program slice with the slicing criterion <s, v>, where s is the statement number of the push instruction and v is its operand. We expect v to be defined before it is used in the instruction. If these conditions are satisfied, and a library call is suspected, then an alert is flagged. Also, the byte sequences corresponding to the last branch instruction and the program slice are converted to a signature (as described in further detail below).

The second case is the case of an obvious interrupt. This is another case of a branch instruction with an obvious branch target, and the branch target must be a valid interrupt number. In other words, the register eax is set to a meaningful value before the interrupt. Working backwards from the int instruction, the code recognizer 108 searches for the first use of the eax register, and computes a slice at that point. If the eax register is assigned a value between 0-255, then an alert is raised, and the appropriate signature is generated.

The third case is the case of an ret instruction. This instruction alters control flow depending on the stack state. Therefore, we expect to find at some point earlier in the chain either a call instruction, which creates a stack frame or instructions which explicitly set the stack state (such as a push instruction) before ret is called. Otherwise, executing a ret instruction may cause a crash rather than a successful exploit.

The fourth case is the case of a hidden branch target. If the branch target is hidden due to register addressing, then it is sufficient to ensure that the constraints over branch targets described above hold over the corresponding hidden branch target. In this case, the code recognizer 108 computes a slice with the aim of ascertaining whether the operand is being assigned a valid branch target. If so, an alert is generated.

The case of polymorphic exploit code, which may also be tested in step 808, is handled slightly differently. Since only the decryptor body can be expected to be visible and is often implemented as a loop, the code recognizer 108 looks for evidence of a cycle in the reduced CFG, which can be achieved in O(n), where n is the total number of statements in the valid chains. Again, depending on the addressing mode used, the loop itself can be obvious or hidden. For the former case, the code recognizer 108 ascertains that at least one register being used inside the loop body has been initialized outside the body. An alternative check is to verify that at least one register inside the loop body references the network flow itself. If the loop is not obvious due to indirect addressing, then the situation is similar to the fourth case. We expect that the branch target to be assigned a value such that control flow points back to the network flow.

Next, in step 810, the code recognizer 106 performs constraint enforcement using the following three techniques. First, for every vulnerable buffer in a host computer, an attacker can potentially write an arbitrary amount of data past the bounds of the buffer, but this will most likely result in a crash as the writes may venture into unmapped or invalid memory. This is seldom the goal of a remote exploit and in order to be successful, the exploit code has to be carefully constructed to fit inside the buffer. Each vulnerable buffer has a limited size and this in turn puts limits on the size of the transmitted infection vector

Second, the types of branch targets are limited for exploit code. For example, due to the uncertainty involved during a remote infection, control flow cannot be transferred to any arbitrary memory location. Further, due to the above described size constraints, branch targets can be within the payload component and hence, calls/jumps beyond the size of the flow are meaningless. Finally, due to the goals which must be achieved, the exploit code must eventually transfer control to a system call. Thus, branch instructions of interest are the jump (jmp) family, call/return (ret) family, loop family and interrupts.

Third, even an attacker must look to the underlying system call subsystem to achieve any practical goal such as a privileged shell. System calls can be invoked either through the library interface (glibc for Linux and kernel32.dll,ntdll.dll for Windows) or by directly issuing an interrupt. If the former is chosen, then we look for the preferred base load address for libraries which is 0x40 on Linux and 0x77 for Windows. Similarly, for the latter, the corresponding interrupt numbers are int 0x80 for Linux and int 0x2e for Windows. A naive approach to exploit code detection would be to just look for branch instructions and their targets, and verify the above branch target conditions. However, this is not adequate due to the following reasons, necessitating additional analysis. First, although the byte patterns satisfying the above conditions occur with only a small probability in a network flow, it is still not sufficiently small to avoid false positives. Second, the branch targets may not be obvious due to indirect memory addressing (e.g., instead of the form ‘call 0x12345678’, we may have ‘call eax’ or ‘call [eax]’).

In addition to identifying potential exploit code, the code recognizer 108 can also generate signatures of the potential exploit code. Control flow analysis produces a pruned CFG and data flow analysis identifies interesting instructions within valid blocks. A signature is generated based on the bytes corresponding to these instructions. Note that the code recognizer 108 does not convert an entire block in the CFG into a signature because noise from binary disassembly can misrepresent the exploit code and make the signature useless. The main consideration while generating signatures is that while control and data flow analysis may look at instructions in a different light, the signature must contain the bytes in the order of occurrence in a network flow. We use a regular expression representation containing wildcards for signatures since the relevant instructions and the corresponding byte sequences may be disconnected in the network flow.

The foregoing Detailed Description is to be understood as being in every respect illustrative and exemplary, but not restrictive, and the scope of the invention disclosed herein is not to be determined from the Detailed Description, but rather from the claims as interpreted according to the full breadth permitted by the patent laws. It is to be understood that the embodiments shown and described herein are only illustrative of the principles of the present invention and that various modifications may be implemented by those skilled in the art without departing from the scope and spirit of the invention. Those skilled in the art could implement various other feature combinations without departing from the scope and spirit of the invention.

1. A method for monitoring network traffic comprising the steps of:
intercepting network data packets;
generating data flows from said intercepted data packets;
filtering out at least portions of said data flows; and
detecting executable code in unfiltered portions of said data flows.

2. The method of claim 1 wherein said filtering is based upon a set of predetermined rules.

3. The method of claim 1 wherein said step of filtering comprises:
filtering out legitimate program code from said data flows.

4. The method of claim 3 further comprising the step of:
determining if said legitimate program code contains malicious code.

5. The method of claim 1 further comprising the step of:
identifying said detected executable code as a potential exploit.

6. The method of claim 1 wherein said step of detecting executable code comprises:
performing convergent binary disassembly on said unfiltered portions of said data flows.

7. The method of claim 6 wherein said step of detecting executable code further comprises:
constructing a control flow graph; and
performing control flow analysis using said control flow graph.

8. The method of claim 7 wherein said step of detecting executable code further comprises:
performing data flow analysis; and
performing constraint enforcement.

9. The method of claim 1 further comprising the step of:
generating a code signature from said detected executable code.

10. A system for monitoring network traffic comprising:
a network interface for receiving intercepted network data packets;
a flow monitor for generating data flows from said intercepted network data packets;
a content filter for filtering out at least portions of said data flows; and
an executable code recognizer for detecting executable code in unfiltered portions of said data flows.

11. The system of claim 10 wherein said content filter stores a set of filtering rules.

12. The system of claim 10 wherein said content filter filters out legitimate program code from said data flows.

13. The system of claim 12 further comprising:
a malicious program analyzer for determining whether said legitimate program code contains malicious code.

14. The system of claim 10 wherein said executable code recognizer performs convergent binary disassembly.

15. A system for monitoring network traffic comprising:
means for intercepting network data packets;
means for generating data flows from said intercepted data packets;
means for filtering out at least portions of said data flows; and
means for detecting executable code in unfiltered portions of said data flows.

16. The system of claim 15 wherein said means for filtering comprises a set of predetermined rules.

17. The system of claim 15 wherein said means for filtering comprises:
means for filtering out legitimate program code from said data flows.

18. The system of claim 17 further comprising:
means for determining if said legitimate program code contains malicious code.

19. The system of claim 15 further comprising:
means for identifying said detected executable code as a potential exploit.

20. The system of claim 15 wherein said means for detecting executable code comprises:
means for performing convergent binary disassembly on said unfiltered portions of said data flows.

21. The system of claim 20 wherein said means for detecting executable code further comprises:
means for constructing a control flow graph; and
means for performing control flow analysis using said control flow graph.

22. The system of claim 21 wherein said means for detecting executable code further comprises:
means for performing data flow analysis; and
means for performing constraint enforcement.

23. The system of claim 15 further comprising:
means for generating a code signature from said detected executable code.
